(19) United States
(12) Patent Application Publication
(10) Pub. No.: US 2024/0286228 A1
(43) Pub. Date: Aug. 29, 2024

(54) SYSTEM AND METHOD FOR MONITORING WELDED JOINTS

(71) Applicant: FLUOR TECHNOLOGIES CORPORATION, Irving, TX (US)

(72) Inventors: Gary R. CANNELL, Richland, WA (US); Wayland T. MAY, Belton, SC (US)

(21) Appl. No.: 18/044,930

(22) PCT Filed: Feb. 2, 2023
(86) PCT No.: PCT/US2023/061862

§ 371 Date: Mar. 10, 2023

Related U.S. Application Data
(60) Provisional application No. 63/352,923, filed on Jun. 16, 2022.

(51) Int. Cl. B23K 31/12; B23K 31/00; B23K 31/02

(52) U.S. Cl. CPC B23K 31/125; B23K 31/02; B23K 31/006

(57) ABSTRACT

A method of monitoring a welding process can include adaptively welding a first workpiece to a second workpiece to form a welded joint, monitoring the welded joint during the adaptive welding using one or more sensors, receiving one or more welding parameters from the one or more sensors, using the one or more welding parameters with a welding envelope, and determining a weld quality of the welded joint using the welding envelope. The welding envelope can define a boundary for an acceptable weld quality based on the one or more welding parameters.

### CROSS-REFERENCE TO RELATED APPLICATIONS

The present application claims priority to U.S. Provisional Patent Application No. 63/352,923 filed on Jun. 16, 2022 and entitled “Systems and Methods for Adaptive Welding,” the disclosure of which is incorporated herein by reference in its entirety.

### STATEMENT REGARDING FEDERALLY SPONSORED RESEARCH OR DEVELOPMENT

Not applicable.

### SUMMARY

In an embodiment, a method of monitoring a welding process comprises adaptively welding a first workpiece to a second workpiece to form a welded joint, monitoring the welded joint during the adaptive welding using one or more sensors, receiving one or more welding parameters from the one or more sensors, using the one or more welding parameters with a welding envelope, and determining a weld quality of the welded joint using the welding envelope. The welding envelope can define a boundary for an acceptable weld quality based on the one or more welding parameters.

In an embodiment, a system comprises a controller comprising a processor and a memory that stores a monitoring program. The monitoring program, when executed on the processor, configures the processor to receive one or more welding parameters from one or more sensors associated with a welding system during the formation of a welded joint, use the one or more welding parameters with a welding envelope, and determine a weld quality of the welded joint using the welding envelope. The welding envelope defines a boundary for an acceptable weld quality based on the one or more welding parameters.

In an embodiment, a method of determining a welding envelope for operation of a welding system comprises receiving one or more welding parameters during the formation of a welded joint between a first workpiece and a second workpiece, receiving an indication of a quality of the welded joint, correlating the one or more welding parameters with the indication of the quality of the welded joint to form a correlated data set, and determining a welding envelope based on the correlated data set. The welding envelope defines a boundary for an acceptable weld quality based on the one or more welding parameters.

These and other features will be more clearly understood from the following detailed description taken in conjunction with the accompanying drawings and claims.

### BACKGROUND

Welding involves heating two workpieces (e.g., metallic work pieces) and joining them either directly or via an additional welding material (e.g., a welding rod). A welded seam between two work pieces may be formed by a skilled welding technician, and following such a manual welding operation, the quality of the weld seam may be inspected (e.g., visually, using x-rays or other scanning technology) to ensure a sufficient bond has been achieved. Such post-weld inspections are especially prevalent in weld seams for sealed enclosures (e.g., pressure vessels or other sealed barriers and vessels).

### BRIEF DESCRIPTION OF THE DRAWINGS

For a detailed description of various exemplary embodiments, reference will now be made to the accompanying drawings in which:

FIG. 1 is a side view of a welding system for automated adaptive welding according to some embodiments; and

FIG. 2 is a top view of the welding system of FIG. 1 according to some embodiments.

FIGS. 3A and 3B illustrate cross-sectional views of weld types according to some embodiments.

### DETAILED DESCRIPTION

As previously described, the quality of a manually formed weld seam may be inspected to ensure a sufficient weld quality. However, there is growing shortage of qualified welding technicians that can perform welding operations, especially for particular welding methods and/or applications. Even with a qualified welding technician, defects can occur in a weld that may only be detected after the weld is formed. For large projects, detection of the defects can be difficult, and repairing the defects may involve removing large portions of the weld for the work to be reperformed. Further, current processes require the entire weld to be completed in order for certain testing to be performed such as leak testing. The inability to inspect a weld until the project is complete can result in a large amount of rework being performed.

Accordingly, the embodiments described herein include systems and methods for automated adaptive welding and weld certifications that may reduce a reliance on skilled welding technicians, improve weld quality, and allow for post certification of the weld based on the formation of the weld within a welding envelope. Through use of the automated adaptive welding systems and methods of the embodiments disclosed herein, welded joints may be formed without reliance on a skilled welding technician while allowing for in-situ monitoring and correction as needed.

The systems and methods described herein can use process or weld pre-qualification, adaptive welding to create the welds, and automated examination as part of the welding process in order to allow the welds to be certified once completed. The pre-qualification step can be used to obtain data and parameters from sensors during the welding on the types of welds to be performed using an adaptive welding system and processes. Testing on the resulting welded joints can then be performed to identify the parameters and ranges or values that can create suitable welds having weld qualities in a desired range. Using the measured data and parameters along with the post welding testing and certifications, welding parameters can be identified that affect the weld quality, and operating parameters or ranges can be determined for the various welding parameters. As described in more detail herein, various types of analysis such as a statistical analysis, machine learning approach, or the like can be used to identify a welding envelope defining a parameter set that can lead to a certifiable weld. This process may be referred to as pre-qualification process to develop a welding envelope to obtain a desired weld quality.

Once the parameters defining the welding envelope are determined, adaptive welding can be used to form the weld and maintain the welding parameters within the welding envelope. Sensors can provide outputs in real time to maintain the parameters within the welding envelope during the weld formation as part of the adaptive welding process.

The sensor outputs can be monitored and/or recorded during the welding process, and when the welding parameters are maintained within the welding envelope, the weld can be certified based on the measured parameters during the weld formation. The monitoring process can be considered to be a type of real-time non-destructive examination (NDE). The sensors monitoring the weld during the process can be compared to the welding envelope and/or models to determine if the weld can be certified. For any parameters falling outside of the welding envelope and/or not meeting the criteria of the models during the welding, the system can determine that a defect has occurred. In this instance, the welding process can be stopped, and the defect can be repaired prior to continuing the weld. This process may occur in real time to allow defects to be detected quickly without completing the weld. This may allow for faster identification of defects as well as providing for an indication of the location for the defect.

The present systems and methods may allow for welds to be certified without the need for post-weld inspection. This process can be carried out by demonstrating that the welding process occurs within the welding envelope, which together with the pre-qualification process, can result in quickly certifying a weld once it is completed. The process may also allow for more reliable welds with fewer defects based on the use of an adaptive welding system. Any defects that occur can be quickly corrected to reduce the overall welding costs. In addition, different welds that use less welding material may also be used to help reduce the overall cost.

In some aspects, the processes and systems described herein can be used for a variety of industries. The ability to continuously monitor a welding process and welded joint can allow for sound and high-quality welds to be certified, such as gas tight welds. This can allow the systems and methods to be used in industries such as the nuclear industry where gas tight welds (e.g., in storage containers, etc.) and water tight welds (e.g., reactor pool walls, etc.) may be needed. While described with respect to high quality welds, the systems and methods described herein can also be used to ensure consistent welds across the entire welded joint of any quality, where the quality level can be taken into account in developing and using a welding envelope.

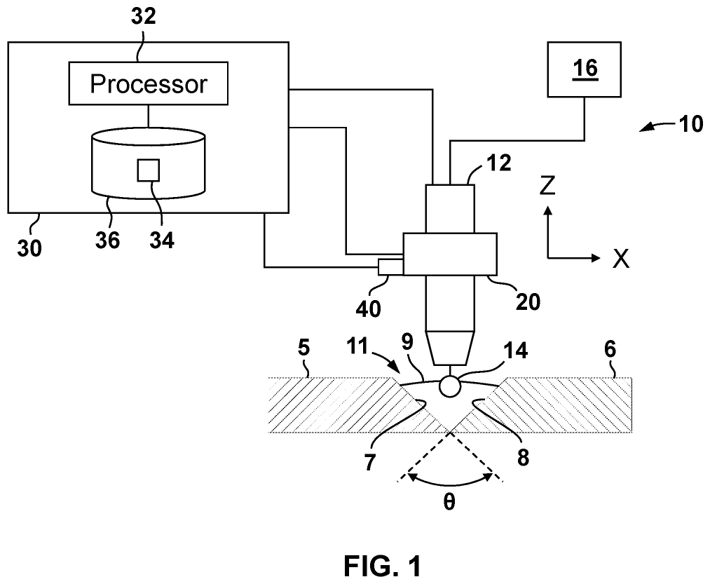

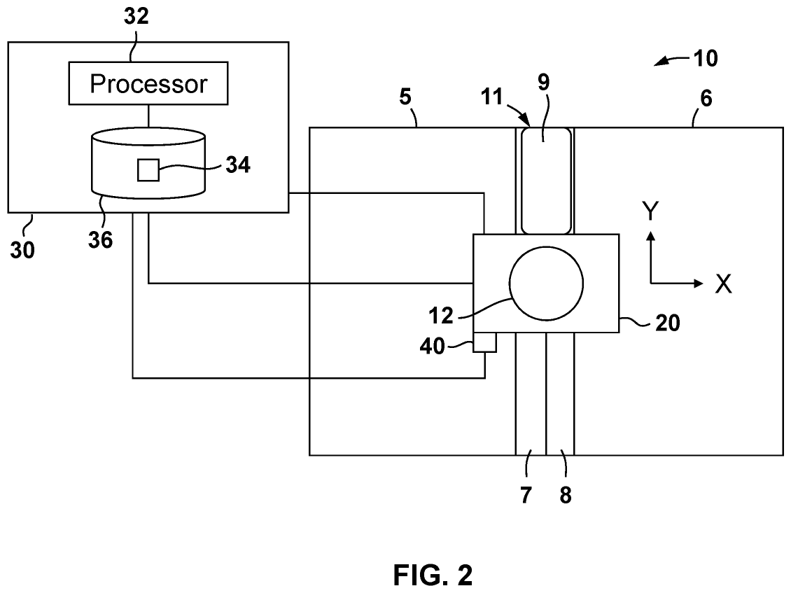

In some aspects, the systems and methods as described herein can use adaptive welding processes and systems. Referring now to FIGS. 1 and 2, a welding system 10 for automated adaptive welding according to some embodiments is shown. System 10 includes a welding tool 12 that is coupled to and supported by an actuation mechanism 20. The welding tool 12 can include any suitable welding device that is capable of forming a weld between two workpieces 5, 6. In some aspects, the welding tool 12 may comprise a gas tungsten arc welding (GTAW) tool (that is configured to perform GTAW), and thus may include an electrode 14 that is electrically energized during welding operations. The electrode 14 may be a non-consumable electrode in some aspects. For example, the electrode 14 can comprise tungsten and be “non-consumable” during a welding operation. A shielding gas 16 can be supplied to the electrode 14 via the welding tool 12 to protect the electrode 14 and the welding seam from oxidation. In some aspects, other welding tools such as general arc welding tools, torches, and the like can be used with the system and methods described herein.

The actuation mechanism 20 may comprise one or more actuators that are configured to move the welding tool 12 in a three-dimensional (3D) space. Specifically, the welding tool may be moved along three orthogonal axes X, Y, and Z noted in FIGS. 1 and 2 via the actuation mechanism 20 (where the Z axis is perpendicular to the X and Y axes as shown in the FIGS.). The actuation mechanisms 20 may comprise linear actuators (e.g., pneumatic or hydraulic cylinders), electric motors (e.g., servo motor, stepper motor, etc.), gearing or belt systems (e.g., rack and pinion systems, gear chains, belts, etc.), or a combination of these components for moving the welding tool 12 (and most particularly the electrode 14) along the axes X, Y, and Z.

Both the welding tool 12 and the actuation mechanism 20 can be coupled (e.g., communicatively coupled) to an electronic device 30. In some embodiments, the welding tool 12 and actuation mechanism 20 can be coupled to the electronic device 30 via a wired connection (e.g., metallic wire, fiber optic cable, etc.), a wireless connection (e.g., RF communication, Wi-Fi, infrared communication, acoustic pulse communication, BLUETOOTH®, etc.), or a combination of wired and wireless connections. In some embodiments, the electronic device 30 can be communicatively coupled to the welding tool 12 and/or the actuation mechanism 20 via a communications network (e.g., the Internet).

The electronic device 30 may comprise a computing device, such as a personal computer (e.g., desktop computer, laptop computer), smart phone, server, or a combination of two or more of these devices. Generally speaking, electronic device 30 may control or adjust one or more parameters or actuations of the actuation mechanism 20 and the welding tool 12 during a welding operation. Thus, the electronic device 30 may be referred to herein as a “controller” of the welding system 10, and particularly a “controller” of the actuation mechanism 20 and the welding tool 12.

The electronic device 30 can include a processor 32 and a memory 34 coupled to processor 32. The processor 32 may comprise any suitable processing device, such as a microcontroller, central processing unit (CPU), graphics processing unit (GPU), timing controller (TCON), scaler unit. The processor 32 executes machine-readable instructions (e.g., machine-readable instructions 36) stored on memory 34, thereby causing the processor 32 to perform some or all of the actions attributed herein to the electronic device 30. In general, processor 32 fetches, decodes, and executes instructions (e.g., machine-readable instructions 36). In addition, processor 32 may also perform other actions, such as, making determinations, detecting conditions or values, etc., and communicating signals. If processor 32 assists another component in performing a function, then processor 32 may be said to cause the component to perform the function.

The memory 34 may comprise volatile storage (e.g., random access memory (RAM)), non-volatile storage (e.g., flash storage, read-only memory (ROM), etc.), or combinations of both volatile and non-volatile storage. Data read or written by the processor 32 when executing machine-readable instructions 36 can also be stored on memory 34. Memory 34 may comprise “non-transitory machine-readable medium,” where the term “non-transitory” does not encompass transitory propagating signals.

The processor 32 may comprise one processing device or a plurality of processing devices that are distributed within electronic device 30 or a plurality of electronic devices (e.g., electronic device 30). Likewise, the memory 34 may comprise one memory device or a plurality of memory devices that are distributed within electronic device 34 or a plurality of electronic devices (e.g., electronic device 34).

During operations, the welding system 10 may be used to form a welded seam or joint 11 between two workpieces. For instance, in FIGS. 1 and 2, the welding system 10 is illustrated as forming a welded joint 11 between a first workpiece 5 and a second workpiece 6. In some embodiments, the workpieces 5, 6 may comprise a metallic and/or composite material. The first workpiece 5 has a first chamfer 7, and the second workpiece 6 has a second chamfer 8. The first and second chamfers 7, 8, respectively, are engaged with one another such that electrode 14 may be traversed along the line of engagement between the first and second chamfers 7, 8 to form a weld bead 9 that joins the workpieces 5, 6 (and thus defines the welded joint 11).

The chamfers 7, 8 of workpieces 5, 6, respectively, can be flat surfaces that extend at an angle θ to one another. In some embodiments, the angle θ between chamfers 7, 8 may be relatively narrow, such as, for instance less than 75°. Thus, the joint formed by the chamfers 7, 8 may be referred to herein as a “narrow groove” joint.

In some embodiments, one or more sensors 40 may be communicatively coupled to electronic device 30 that may detect one or more properties of the welding system 10, including one or more position sensors to detect the position of the electrode 14, the previously traveled path of the electrode 14, the speed of the electrode 14 relative to the workpieces 5, 6, etc., and/or a sensor such as an optical sensor (e.g., image sensor, video sensor, etc.) to detect the size and shape of the weld bead 9. Additional sensors associated with the welding system 10 can include electrical sensors associated with the device and electrode to measure electrical properties (e.g., voltage, amperage, current, resistance, etc.), a sensor to detect the arc or torch properties, and/or welding supply sensors such as sensors to measure the wire feed rate, feed angle, etc. The one or more sensors 40 may comprise a plurality of sensors (e.g., a sensor array) that are coupled to one or more of the welding tool 12, the actuation mechanism 20, the work pieces 5, 6, or that are independently supported from the welding tool 12, actuation mechanism 20, work pieces 5, 6, etc. (e.g., such as on a frame, stand, or other support assembly).

During welding operations with welding system 10, the electronic device 30 (via processor 32 executing machine-readable instructions 36 stored on memory 34) may control the movement of the welding tool 12 via the actuation mechanism 20 and may adjust one or more of the welding parameters applied by welding tool 12 to form the welded joint 11 between the workpieces 5, 6. For instance, the electronic device 30 may actively adjust one or more of the electric current applied to the electrodes 14 (e.g., voltage, amperage, etc.), the travel speed (e.g., in the X, Y, and Z directions) of the welding tool 12, the size (e.g., width, depth, etc.) of the weld bead 9, the oscillation pattern (and/or speed) of the electrode 14 across the chamfers 7, 8, the arc parameters (e.g., arc length, arc angle, etc.), the wire feed rate and wire feed angle (for welding applications utilizing welding wire), etc.

During these operations, the electronic device 30 may utilize one or more algorithms or relationships to adjust the parameters of the welding operation. For instance, the electronic device 30 may receive the detected sensor outputs to determine the properties of the welding operations via the one or more sensors 40, and then may provide these detected properties to the relationships to thereby determine one or more adjustments to the welding operations previously described above.

Thus, during operations, the electronic device 30 of welding system 10 may, via processor 32 executing machine-readable instruction 34, automatically perform a welding operation to form the welded joint 11 between workpieces 5, 6. Therefore, welding operations with welding system 10 may be described as “automated,” such that the services of a skilled welding technician may not be needed to form the welded joint itself. In some embodiments, a welding operation with welding system 10 may be controlled or at least initiated from a location that is remote from the welding system 10 (e.g., in a different building, region, country, etc.). For instance, a welding operation may be controlled or at least initiated by a technician that is located remotely from the welding system 10 by communicating with the electronic device 30 via a network (e.g., a Wireless Local Area Network (WLAN), a Wireless Wide Area Network (WWAN), the Internet, a cellular network, a wired network, etc.). Thus, through use of the embodiments disclosed herein, a welding operation may be more efficient and less reliant on an ever-decreasing workforce of skilled welding technicians.

Within this process, the adaptive welding process can capture welding data and welding parameters using the one or more sensors 40. The data can be processed to provide an input to the electronic device 30, which can use the control system and/or algorithms to provide the adjustments of the welding parameters. For example, the electronic device 30 can provide changes to adjust the adaptive welding path track and placement, the bead width, the fill-volume management, and the like. The resulting welded joint 11 can then be formed based on the continuously updated and controlled welding process. As described in more detail herein, the welding data can be used with other data to identify if the welded joint falls within a welding envelope to indicate that the joint meets a desired weld quality.

The welding process described herein can include a pre-qualification process to develop a welding envelope. The pre-qualification process can be used to identify and develop one or more welding envelopes defining parameters and relationships among the parameters that can result in a desired weld quality, which may allow the weld to be certified as described in more detail herein. The pre-qualification process can start with performing one or more welds to form welded joints, monitoring various sensors outputs and welding parameters, testing the resulting welded joints to determine the weld qualities, and developing welding envelopes that define acceptable ranges of parameters that will form welds within the desired weld quality.

The pre-qualification process can begin by performing adaptive welding as described above. The workpieces 5, 6 can be production workpieces used in a final product or structure, or in some aspects, the workpieces 5, 6 can be coupons or sample workpieces used to develop the welding envelopes. Regardless of the type of workpieces, the adaptive welding process can be carried out as described with respect to FIGS. 1 and 2, and the sensor outputs from the one or more sensors 40 associated with the welding system 10 can be monitored and stored as part of the welding process.

In addition to the sensors associated with the welding system 10, additional sensors may also be present and used for purposes of monitoring the weld quality. These additional sensors may or may not be coupled to the controller 30, and/or used to control the welding system 10. For example, the additional sensors may only be used for purposes of determining the welding envelope and weld quality and not used to control the welding system 10 during the adaptive welding process. Additional parameters that may be measured, if not already measured by the one or more sensors 40 associated with the welding system 10, can include, but are not limited to, an adaptive weld path track and placement, adaptive bead width, adaptive fill-volume management, and an indication of a defect in the welded joint. In some aspects, one or more of these parameters may be derived from the output of one or more sensors. For example, the fill volume may be derived from the wire feed rate, weld path movement rate, and/or a visual inspection of the resulting weld width and height along with the known parameters of the welding track.

Additional sensors that can be used with the monitoring system can include sensors such as a sensor to detect the position, size, and shape of the welded joint 11, including the weld bead 9. This sensor may be present as part of the welding system 10, but if not present on the welding system 10, may be separately supplied to identify the properties of the weld bead 9 and resulting weld. Exemplary sensors can include image sensors, ultrasonic sensors, and the like. In some aspects, one or more weld monitoring systems capable of detecting surface or subsurface defects in the weld may also be present. For example, an eddy current (EC) sensor may be used to identify one or more surface or subsurface defects such as a crack, discontinuity, void, or the like within the volume of the weld bead 9, at the interface between the weld bead 9 and the workpiece(s) 5, 6, and/or within the surround body of the workpiece(s) 5, 6 at or near the weld bead 9 interfaces. Various sensors such as electromagnetic sensors, ultrasonic sensors, and the like may be used with or in place of EC sensors. The additional sensors may be positioned at or behind the welding tool 12 to allow for a measurement of the welded joint 11 as it is formed. For example, the additional sensors may be positioned within about 0.5 inch (in.) to about 12 in. behind the welding tool 12, though any suitable distance that can correlate the sensor data with the data obtained from the welding system 10 sensors 40 may also be used.

The data from the one or more sensors 40 and the additional sensors may be detected during the welding process. The sensor data may be processed using various methods to produce parameter values of the various sensors that can be correlated with and stored with position data for the welded joint 11. For example, the position sensor data may be processed to correlate a position of the welding tool 20 relative to the welded joint 11. Similarly, an image sensor output may be processed to identify one or more features of the weld bead 9 so that the one or more features (e.g., height, width, shape, etc.) can be used for further processing. In some embodiments, the parameters that can be detected and used to develop the welding envelope can include, but are not limited to, one or more of the following: a position of the electrode, a traveled path of the electrode (e.g., linear and/or oscillation position, speed, or path), a speed of the electrode relative to the workpieces, a size (e.g., width, depth, etc.) and shape of the weld bead, one or more electrical properties (e.g., voltage, amperage, current, resistance, etc.), arc or torch properties, welding material properties such as a wire feed rate or a feed angle, a fill-volume management, an indication of a surface or subsurface defects. In some aspects, one or more additional parameters or features may be derived from the output of one or more sensors. Once the full parameter set is obtained from the sensor data, the parameters may be stored along with the location along the weld, and in some aspects, the original sensor data may be discarded. The resulting parameter set can then be used in further processing to develop the welding envelope.

Once the welded joint 11 is completed, one or more testing or examination processes can be performed to identify the quality of the weld. The examination processes can include NDE processes and/or destructive examination processes. When the completed workpiece is used as a product, the testing may only involve NDE processes. In some aspects, the welded joints may be formed in testing materials such as testing coupons that can be tested using destructive testing processes alone or in combination with NDE processes. Various NDE processes can be used to test the welded joint 11. Suitable testing processes can include, but are not limited to, visual welding inspection (VT), penetrant testing (PT), water tight testing, helium leak testing, ultrasonic testing, x-ray testing, and the like. When used, destructive testing may be used after NDE processes to provide additional data. Destructive testing may involve cutting, boring, etching, and/or polishing the welded joint 11 at one or more locations to observe the internal weld structure. The use of a destructive testing process can result in the destruction of the welded joint while providing information that may not be possible to observe without the use of such destructive testing techniques.

The results of the testing processes can provide an identification of the quality of the weld along the welded joint 11. When defects are identified, the defect locations and types can be correlated with and stored along with the parameter set obtained from the sensors during the welding process. In some aspects, the quality of the weld may also be correlated and stored with the parameter set in association with the position along the welded joint 11. This data set can be referred to as a correlated data set. The resulting correlated data set can then be used to identify the welding envelope. The resulting data set (e.g., the correlated data set) can be considered a labeled data set in some contexts.

The correlated data set can then be used with various processes to identify a welding envelope. As used herein, the welding envelope provides a relationship between one or more of the welding parameters and the final weld quality. In some aspects, the welding envelope can define a boundary for an acceptable weld quality based on one or more of the welding parameters. The weld quality can be selected as part of the determination of the welding envelope to provide for a weld that can satisfy the criteria needed for a predetermined certification. For example, the weld quality for a water tight seal may be different than the weld quality for a gas tight seal, and the welding envelope can provide the relationship between the one or more welding parameters and the weld quality for the selected certification. In some aspects, multiple welding envelopes can be used where each welding envelope represents a different desired weld quality for the entire welded joint.

In some aspects, the welding envelope may provide ranges of acceptable values for one or more of the welding parameters measured during the welding process, where the weld quality can be provided so long as the parameters are maintained within the ranges defined by the welding envelope. In some aspects, the welding envelope may be a statistical or machine learning model that can accept the one or more parameters measured during the welding process, and provide an output representative of the quality of the weld. Within a statistical or machine learning model, the one or more parameters may satisfy certain statistical or mathematical relationships and not be strictly bound within certain ranges or satisfy certain thresholds. Other suitable relationships such as other types of machine learning models (e.g., neural networks, etc.) can also be used to define the welding envelope, where the specific type of model may be based on how the welding envelope is developed with the correlated data set. Overall, the resulting welding envelope can define thresholds, lines, surfaces, volumes, or multi-variable parameter relationships for the one or more welding parameters with a resulting determination of a weld quality.

In some embodiments, the correlated data set can be used with a statistical analysis to identify one or more critical welding parameters. For example, a factorial study can be used to identify a subset of the welding parameters that have the greatest effect on weld quality, and the subset of welding parameters can be used as the correlated data set to determine the welding envelope. The resulting welding envelope can identify ranges or a surface for the subset of parameters that can produce the desired weld quality.

In some embodiments, the welding envelope can be developed using machine learning methodologies such as a neural network, a Bayesian network, a decision tree, a logistical regression model, a normalized logistical regression, or other supervised learning techniques. In some embodiments, the welding envelope may define a relationship between at least two of the plurality of the welding parameters, including in some embodiments combinations, variations, and/or transformations of the welding parameters and the weld quality as identified in the examination process. For example, the welding envelope may comprise a multivariate model in which the two or more welding parameters are variables that may be measured during the welding process.

In the development of the welding envelope, the correlated data set can be used to develop and/or train the model representing the welding envelope. In this process, a portion of the data can be used to derive the models, for example by using statistical analysis and/or supervised learning techniques. A second portion of the data can be used for validating the resulting welding envelopes to within a desired level of accuracy or confidence. The development can be carried out in stages until the welding envelope provides the desired level of confidence in the weld quality based on the provided data set.

The development of the welding envelope can be carried out on an electronic device that may be the same or similar to the electronic device as described with respect to FIGS. 1 and 2. In some aspects, the welding envelope may be developed on an electronic device comprising a processor and a memory containing instructions to perform the development of the welding envelope. The electronic device may be separate and/or remote in time and location from the electronic device 30 used to control the welding system.

The resulting welding envelope may apply to the specific type of welded joint 11 used to develop the welding envelope. For example, the welding envelope that can determine the weld quality may apply to a welded joint 11 formed from the same type of material with the same type of weld, using the same adaptive welding process. In some aspects, the welding envelope may apply to additional types of welded joints and systems within a margin of error. Over time, different types of materials, welds, sensors, adaptive welding systems, and desired weld qualities may be used to develop a plurality of welding envelopes so that a library of welding envelopes can be created and referenced to obtain a welding envelope for each specific workpiece being welded and system being used.

The welding envelope can be used for examination of a welded joint as the welded joint is formed. In this process, an adaptive welding process as described herein can be used to perform a welding process on two workpieces. During the formation of the welded joint, one or more sensors 40 associated with the welding system 10 and/or one or more additional sensors used for monitoring can be used to measure the welding parameters during the welding process and formation of the welded joint. The resulting data can be received and processed to provide a data set compatible with and accepted by the welding envelope. The welding envelope can accept the data set as an input and provide an output indicative of the weld quality. For example, when the welding envelope defines thresholds or ranges of the welding parameters, the measured welding parameters can be compared to each threshold or range, and the weld can be considered to satisfy the welding envelope when the parameters meet the threshold(s) and range(s). As another example, when the welding envelope comprises a statistical model such as a logistical regression model, the measured welding parameters can be used as inputs to the model, and the weld can be considered to satisfy the welding envelope with the output of the model indicates that the weld meets a desired weld quality within a specified level of confidence.

The weld can be determined to be suitable so long as the output of the welding envelope indicates that the weld quality is at or above a desired level. In some instances, the weld can be certified based on maintaining the weld quality within a desired range over the length of the welded joint. The ability to certify the welded joint can also be determined by maintaining the welding parameters (e.g., as measured by the one or more sensors associated with the welding system and/or one or more additional sensors) within the welding envelope during the welding process.

In some aspects, the various sensors used to provide the sensor outputs and data, including any features extracted from the data as applicable, can be used as input into the welding envelope as the welded joint 11 is formed. The continuous use of data with the welding envelope can provide an output of the weld quality as the welded joint 11 is formed. In the event that the welding envelope indicates that the weld quality falls below a level needed for certification of the welded joint 11, the welding process can be halted, and the welded joint can be repaired at or near the welding location. This can allow defects to be repaired during the welding process rather than after the entire welded joint is completed and tested. In some aspect, operation outside of the welding envelope may also indicate an error or defect in the welding system, and the welding system can be repaired prior to continuing the welding process. Once the welded joint is repaired, the welding process can be continued. The completed welded joint can then be determined to be within the welding envelope, which can also be considered to be within a desired weld quality based on the monitoring process as any defects in the welded joint can be repaired prior to completion of the welded joint.

In some aspects, an operating envelope can be determined and used as part of the welding process. The operating envelope can be defined to be within the welding envelope. For example, the operating envelope can use the same sensor inputs or feature as the welding envelop, except that the thresholds, values, or ranges may be entirely within the welding envelope. In some aspects, the operating envelope can have more conservative ranges or thresholds or produce a more conservative range of the sensor inputs and parameters than the welding envelope. When used, the operating envelope can be used to maintain the weld within the welding envelope even if an error or defect is to occur.

In some aspects, the various sensors used to provide the sensor outputs and data, including any features extracted from the data as applicable, can be used as input into the operating envelope as the welded joint 11 is formed. The continuous use of data with the operating envelope can provide an output of the weld quality as the welded joint 11 is formed. In the event that the operating envelope indicates that one or more parameters are outside of the operating envelope, the welding process can be halted. Since the operating envelope can maintain the weld quality within the welding envelope, the welded joint 11 as formed can still be within the desired weld quality so that the weld does not need to be repaired. In this configuration, the operating envelope can be used to avoid the presence of a welded joint 11 that does not meet the desired weld quality even if repairs may be needed. In some aspects, operation of the system outside of the operating envelope may indicate an error in the control system or other portions of the welding system. The welding system may be repaired before continuing the welding process for the welded joint 11 within the operating envelope. The use of the operating envelope can then maintain the welded joint within a level needed for certification of the welded joint 11 during the entire formation process. The completed welded joint formed using the operating envelope can then be determined to be within the welding envelope, which can also be considered to be within a desired weld quality based on the monitoring process as operation within the operating envelope can avoid the formation of any defects.

In some aspects, the use of the welding envelope to monitor the formation of the welded joint can be considered to occur in real time. As used herein, the term “real time” refers to a time that takes into account various communication, processing, and latency delays within a system, and can include actions taken within about five seconds, within about ten seconds, within about thirty seconds, within about a minute, or within about five minutes. The ability to detect any defects or insufficient weld quality in a welded joint can allow for a minimal amount of the welded joint to have to be repaired prior to the completion of the entire welded joint.

The data monitored and used with the welding envelope can be stored in a memory or database during the welding process. The data and the results from the use of the welding envelope can then be used to demonstrate compliance with any applicable standards. This process can be used in some aspects to certify the weld without the need for further post-welding examinations. This can include the ability to avoid any destructive examinations of the weld, and in some aspects, may avoid the need for NDE once the welded joint is completed. Even when post welding NDE processes are needed, their use may be reduced to allow for a faster inspection and examination process.

The application of the welding envelope can be carried out on an electronic device that may be the same or similar to the electronic device 30. Since the electronic device 30 may be processing the welding parameters obtained from the one or more sensors (in addition to those being processed and output by the electronic device 30 acting as a controller), the welding envelope may be used on the same electronic device 30. In some aspects, the welding parameters may be monitored and used with the welding envelope on an electronic device that is separate and/or remote in time and location from the electronic device 30 used to control the welding system.

The ability to monitor the welded joint during the welding process can also allow for new types of welds to be used, including any of those described herein. The ability to use a desired weld type may allow for the amount of weld material to be reduced while still maintaining the desired weld quality, as demonstrated through the use of the welding envelope during the welding process.

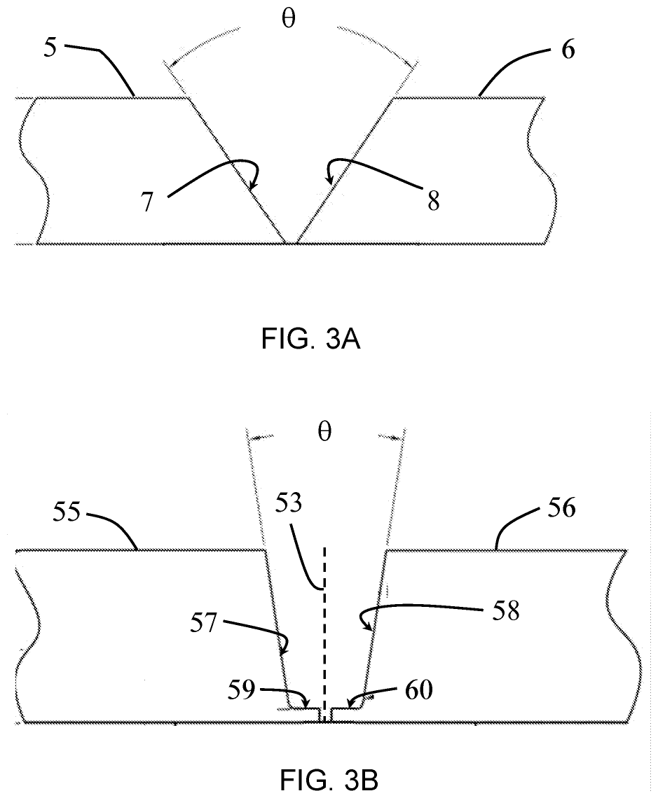

An example of a different weld types are shown in FIGS. 3A and 3B. FIG. 3A demonstrates a weld similar to the welded joint shown in FIG. 1. In this embodiment, the first workpiece 5 has a first chamfer 7, and the second workpiece 6 has a second chamfer 8. The first and second chamfers 7, 8, respectively, can be placed in contact or with a small gap between the first workpiece 5 and the second workpiece 6 to allow for the weld material to fill entirely between the two workpieces 5, 6. During the welding process, the electrode may be traversed along the line of engagement between the first and second chamfers 7, 8 to form a weld bead that joins the workpieces 5, 6 (and thus defines the welded joint). As shown, the chamfers 7, 8 of workpieces 5, 6, respectively, can be relatively flat, linear surfaces that extend at an angle θ to one another. In some embodiments, the angle θ between chamfers 7, 8 may be relatively narrow, such as, for instance less than 75° such that the welded joint 11 may be referred to herein as a “narrow groove” joint.

FIG. 3B illustrates another type of welded joint used to connect the first workpiece 55 and the second workpiece 56. In this embodiment, each workpiece may have a narrowed portion that extends outwards from the joint line 53 before extending across the workpiece to form a chamfered surface on each workpiece 57, 58. The shape can then result in a shoulder 59, 60 being formed on each workpiece 55, 56, respectively. The first and second chamfers 57, 58, respectively, can be placed in contact or with a small gap between the first workpiece 55 and the second workpiece 56 to allow for the weld material to fill entirely between the two workpieces 55, 56. As with other welded joints, the electrode may be traversed along the line of engagement between the first and second chamfers to form a weld bead that joins the workpieces 55, 56 (and thus defines the welded joint). As shown, the chamfers of workpieces 55, 56, respectively, can extend at an angle θ to one another. In some embodiments, the angle θ between chamfers may be narrow, such as, for instance less than about 35°, less than about 30°, less than about 25°, or about 20°. The welded joint may require less weld material to join the two workpieces 55, 56 than when the angle is larger. In the configuration of the weld as shown in FIG. 3B, the distance that the narrowed portion extends away from the joint line 53 can increase as the angle θ becomes smaller.

The weld type as shown in FIG. 3B may require a reduced amount of weld material compared to a wider joint. Using traditional manual welding techniques, such joint configurations may not be able to be formed without defects. However, the use of an adaptive welding process along with the monitoring and use of a welding envelope may allow for these types of joints to be formed while meeting a desired weld quality. This can represent a cost and time savings in forming this type of welded joint 11.

Having described various systems and methods, certain aspects can include, but are not limited to:

In a first aspect, a method of monitoring a welding process comprises: adaptively welding a first workpiece to a second workpiece to form a welded joint; monitoring the welded joint during the adaptive welding using one or more sensors; receiving one or more welding parameters from the one or more sensors; using the one or more welding parameters with a welding envelope, wherein the welding envelope defines a boundary for an acceptable weld quality based on the one or more welding parameters; and determining a weld quality of the welded joint using the welding envelope.

A second aspect can include the method of the first aspect, further comprising: determining that the welded joint has an acceptable weld quality using the weld quality determined from the welding envelope; and certifying the welded joint based on determining that the welded joint has the acceptable weld quality.

A third aspect can include the method of the first aspect, further comprising: determining that the welded joint does not meet an acceptable weld quality using the weld quality determined from the welding envelope; halting the adaptive welding; repairing a portion of the welded joint not meeting the acceptable weld quality; and restarting the adaptive welding after repairing the portion of the welded joint.

A fourth aspect can include the method of any one of the first to third aspects, wherein adaptively welding the first workpiece to the second workpiece comprises: monitoring the one or more welding parameters with a controller; adjusting at least one of the welding parameters using the controller; and forming the welded joint based on the adjusted at least one of the welding parameters.

A fifth aspect can include the method of any one of the first to fourth aspects, wherein monitoring the welded joint during the adaptive welding occurs in real time during the formation of the welded joint.

A sixth aspect can include the method of any one of the first to fifth aspects, wherein the one or more welding parameters comprise at least one of: a position of an electrode forming the welded joint, a traveled path of the electrode, a speed of the electrode relative to the first workpiece or the second workpiece, a size of a weld bead, a shape of the weld bead, one or more electrical properties of a welding system forming the welded joint, one or more welding material properties, a fill-volume management, or an indication of surface or subsurface defects.

A seventh aspect can include the method of any one of the first to sixth aspects, wherein the one or more sensors comprise an eddy current sensor, an optical sensor, or an ultrasonic sensors configured to monitor the welded joint.

An eighth aspect can include the method of any one of the first to seventh aspects, wherein the welded joint comprises a weld bead disposed between the first workpiece and the second workpiece, wherein the first workpiece comprises a first chamfered surface angled away from the weld bead, wherein the second workpiece comprises a second chamfered surface angled away from the weld bead, and wherein an angle between the first chamfered surface and the second chamfered surface is less than or equal to about 75 degrees.

A ninth aspect can include the method of the eighth aspect, wherein the angle between the first chamfered surface and the second chamfered surface is less than or equal to about 25 degrees.

In a tenth aspect, a system comprises: a controller comprising a processor and a memory, wherein the memory stores a monitoring program that when executed on the processor, configures the processor to: receiving one or more welding parameters from one or more sensors associated with a welding system during the formation of a welded joint; use the one or more welding parameters with a welding envelope, wherein the welding envelope defines a boundary for an acceptable weld quality based on the one or more welding parameters; and determine a weld quality of the welded joint using the welding envelope.

An eleventh aspect can include the system of the tenth aspect, wherein the processor is further configured to: determine that the welded joint has an acceptable weld quality using the weld quality determined from the welding envelope; and certify the welded joint based on determining that the welded joint has the acceptable weld quality.

A twelfth aspect can include the system of the tenth aspect, wherein the processor is further configured to: determine that the welded joint does not meet an acceptable weld quality using the weld quality determined from the welding envelope; and generate a signal to halt the welding system.

A thirteenth aspect can include the system of any one of the tenth to twelfth aspects, wherein the processor is further configured to: monitor the one or more welding parameters during the formation of the welded joint; and adjust at least one welding parameter, wherein the welded joint is formed based on the adjusted at least one of the welding parameters.

A fourteenth aspect can include the system of the thirteenth aspect, wherein the processor is configured to monitor the welded joint during the adaptive welding in real time during the formation of the welded joint.

A fifteenth aspect can include the system of any one of the tenth to fourteenth aspects, wherein the one or more welding parameters comprise at least one of: a position of an electrode forming the welded joint, a traveled path of the electrode, a speed of the electrode relative to the first workpiece or the second workpiece, a size of a weld bead, a shape of the weld bead, one or more electrical properties of a welding system forming the welded joint, one or more welding material properties, a fill-volume management, or an indication of surface or subsurface defects.

A sixteenth aspect can include the system of any one of the tenth to fifteenth aspects, further comprising: an adaptive welding system in signal communication with the controller, wherein the adaptive welding system comprises: a welding tool; an actuation mechanism configured to move the welding tool; and at least a portion of the one or more sensors.

A seventeenth aspect can include the system of any one of the tenth to sixteenth aspects, wherein the one or more sensors comprise at least one of: a position sensor configured to detect a position of a welding tool, a sensor configured to detect one or more properties of a weld bead formed as part of the welded joint, an electrical sensor configured to detect at least one electrical property of the welding system, a welding material sensor configured to detect at least one property of a welding material fed to the welding system; or an eddy current sensor configured to detect a defect in the welded joint.

In an eighteenth aspect, a method of determining a welding envelope for operation of a welding system comprises: receiving one or more welding parameters during the formation of a welded joint between a first workpiece and a second workpiece; receiving an indication of a quality of the welded joint; correlating the one or more welding parameters with the indication of the quality of the welded joint to form a correlated data set; and determining a welding envelope based on the correlated data set, wherein the welding envelope defines a boundary for an acceptable weld quality based on the one or more welding parameters.

A nineteenth aspect can include the method of the eighteenth aspect, further comprising: forming the welded joint; and measuring the one or more welding parameters while forming the welded joint.

A twentieth aspect can include the method of the nineteenth aspect, wherein forming the welded joint comprises using an adaptive welding process to form the welded joint.

A twenty first aspect can include the method of any one of the eighteenth to twentieth aspects, wherein the one or more welding parameters comprise at least one of: a position of an electrode forming the welded joint, a traveled path of the electrode, a speed of the electrode relative to the first workpiece or the second workpiece, a size of a weld bead, a shape of the weld bead, one or more electrical properties of a welding system forming the welded joint, one or more welding material properties, a fill-volume management, or an indication of surface or subsurface defects.

A twenty second aspect can include the method of any one of the eighteenth to twenty first aspects, further comprising: performing one or more examination processes on the welded joint; and determining the indication of the quality of the welded joint based on the one or more examination processes.

A twenty third aspect can include the method of any one of the eighteenth to twenty second aspects, wherein determining the welding envelope comprises: using the correlated data set as a training set in a machine learning model; and training the machine learning model using the correlated data set to create a trained model, wherein the welding envelope is the trained model.

A twenty fourth aspect can include the method of any one of the eighteenth to twenty third aspects, wherein determining the welded envelop comprises: performing a statistic analysis on the correlated data set; and developing the welding envelope based on the statistical analysis of the correlated data set.

The discussion above is directed to various exemplary embodiments. However, one of ordinary skill in the art will understand that the examples disclosed herein have broad application, and that the discussion of any embodiment is meant only to be exemplary of that embodiment, and not intended to suggest that the scope of the disclosure, including the claims, is limited to that embodiment.

The drawing figures are not necessarily to scale. Certain features and components herein may be shown exaggerated in scale or in somewhat schematic form and some details of conventional elements may not be shown in interest of clarity and conciseness.

In the discussion herein and in the claims, the terms “including” and “comprising” are used in an open-ended fashion, and thus should be interpreted to mean “including, but not limited to . . . .” Also, the term “couple” or “couples” is intended to mean either an indirect or direct connection. Thus, if a first device couples to a second device, that connection may be through a direct connection of the two devices, or through an indirect connection that is established via other devices, components, nodes, and connections. In addition, as used herein, the terms “axial” and “axially” generally mean along or parallel to a given axis (e.g., central axis of a body or a port), while the terms “radial” and “radially” generally mean perpendicular to the given axis. For instance, an axial distance refers to a distance measured along or parallel to the axis, and a radial distance means a distance measured perpendicular to the axis. Further, when used herein (including in the claims), the words “about,” “generally,” “substantially,” “approximately,” and the like mean within a range of plus or minus 10%.

While exemplary embodiments have been shown and described, modifications thereof can be made by one skilled in the art without departing from the scope or teachings herein. The embodiments described herein are exemplary only and are not limiting. Many variations and modifications of the systems, apparatus, and processes described herein are possible and are within the scope of the disclosure. Accordingly, the scope of protection is not limited to the embodiments described herein, but is only limited by the claims that follow, the scope of which shall include all equivalents of the subject matter of the claims. Unless expressly stated otherwise, the steps in a method claim may be performed in any order. The recitation of identifiers such as (a), (b), (c) or (1), (2), (3) before steps in a method claim are not intended to and do not specify a particular order to the steps, but rather are used to simplify subsequent reference to such steps.

What is claimed is:

1. A method of monitoring a welding process, the method comprising:
adaptively welding a first workpiece to a second workpiece to form a welded joint;
monitoring the welded joint during the adaptive welding using one or more sensors;
receiving one or more welding parameters from the one or more sensors;
using the one or more welding parameters with a welding envelope, wherein the welding envelope defines a boundary for an acceptable weld quality based on the one or more welding parameters; and
determining a weld quality of the welded joint using the welding envelope.

2. The method of claim 1, further comprising:
determining that the welded joint has an acceptable weld quality using the weld quality determined from the welding envelope; and
certifying the welded joint based on determining that the welded joint has the acceptable weld quality.

3. The method of claim 1, further comprising:
determining that the welded joint does not meet an acceptable weld quality using the weld quality determined from the welding envelope;
halting the adaptive welding;
repairing a portion of the welded joint not meeting the acceptable weld quality; and
restarting the adaptive welding after repairing the portion of the welded joint.

4. The method of claim 1, wherein adaptively welding the first workpiece to the second workpiece comprises:
monitoring the one or more welding parameters with a controller;
adjusting at least one of the welding parameters using the controller; and
forming the welded joint based on the adjusted at least one of the welding parameters.

5. The method of claim 4, further comprising:
determining an operating envelope, wherein the operating envelope uses the one or more welding parameters and is configured to maintain the one or more parameters entirely within the welding envelope; and
maintaining the one or more parameters within the operating envelope using the controller.

6. The method of claim 1, wherein monitoring the welded joint during the adaptive welding occurs in real time during the formation of the welded joint.

7. The method of claim 1, wherein the one or more welding parameters comprise at least one of: a position of an electrode forming the welded joint, a traveled path of the electrode, a speed of the electrode relative to the first workpiece or the second workpiece, a size of a weld bead, a shape of the weld bead, one or more electrical properties of a welding system forming the welded joint, one or more welding material properties, a fill-volume management, or an indication of surface or subsurface defects.

8. The method of claim 1, wherein the one or more sensors comprise an eddy current sensor, an optical sensor, or an ultrasonic sensors configured to monitor the welded joint.

9. The method of claim 1, wherein the welded joint comprises a weld bead disposed between the first workpiece and the second workpiece, wherein the first workpiece comprises a first chamfered surface angled away from the weld bead, wherein the second workpiece comprises a second chamfered surface angled away from the weld bead, and wherein an angle between the first chamfered surface and the second chamfered surface is less than or equal to about 75 degrees.

10. The method of claim 9, wherein the angle between the first chamfered surface and the second chamfered surface is less than or equal to about 25 degrees.

11. A system comprising:
a controller comprising a processor and a memory, wherein the memory stores a monitoring program that when executed on the processor, configures the processor to:
receive one or more welding parameters from one or more sensors associated with a welding system during the formation of a welded joint;
use the one or more welding parameters with a welding envelope, wherein the welding envelope defines a boundary for an acceptable weld quality based on the one or more welding parameters; and
determine a weld quality of the welded joint using the welding envelope.

12. The system of claim 11, wherein the processor is further configured to:
determine that the welded joint has an acceptable weld quality using the weld quality determined from the welding envelope; and
certify the welded joint based on determining that the welded joint has the acceptable weld quality.

13. The system of claim 11, wherein the processor is further configured to:
determine that the welded joint does not meet an acceptable weld quality using the weld quality determined from the welding envelope; and
generate a signal to halt the welding system.

14. The system of claim 11, wherein the processor is further configured to:
monitor the one or more welding parameters during the formation of the welded joint; and
adjust at least one welding parameter, wherein the welded joint is formed based on the adjusted at least one of the welding parameters.

15. The system of claim 14, wherein the processor is configured to monitor the welded joint during the adaptive welding in real time during the formation of the welded joint.

16. The system of claim 11, wherein the one or more welding parameters comprise at least one of: a position of an electrode forming the welded joint, a traveled path of the electrode, a speed of the electrode relative to the first workpiece or the second workpiece, a size of a weld bead, a shape of the weld bead, one or more electrical properties of a welding system forming the welded joint, one or more welding material properties, a fill-volume management, or an indication of surface or subsurface defects.

17. The system of claim 11, further comprising:
an adaptive welding system in signal communication with the controller, wherein the adaptive welding system comprises:
a welding tool;
an actuation mechanism configured to move the welding tool; and
at least a portion of the one or more sensors.

18. The system of claim 11, wherein the one or more sensors comprise at least one of: a position sensor configured to detect a position of a welding tool, a sensor configured to detect one or more properties of a weld bead formed as part of the welded joint, an electrical sensor configured to detect at least one electrical property of the welding system, a welding material sensor configured to detect at least one property of a welding material fed to the welding system; or an eddy current sensor configured to detect a defect in the welded joint.

19. A method of determining a welding envelope for operation of a welding system, the method comprising:
receiving one or more welding parameters during the formation of a welded joint between a first workpiece and a second workpiece;
receiving an indication of a quality of the welded joint;
correlating the one or more welding parameters with the indication of the quality of the welded joint to form a correlated data set; and
determining a welding envelope based on the correlated data set, wherein the welding envelope defines a boundary for an acceptable weld quality based on the one or more welding parameters.

20. The method of claim 19, further comprising:
forming the welded joint; and
measuring the one or more welding parameters while forming the welded joint.

21. The method of claim 20, wherein forming the welded joint comprises using an adaptive welding process to form the welded joint.

22. The method of claim 19, wherein the one or more welding parameters comprise at least one of: a position of an electrode forming the welded joint, a traveled path of the electrode, a speed of the electrode relative to the first workpiece or the second workpiece, a size of a weld bead, a shape of the weld bead, one or more electrical properties of a welding system forming the welded joint, one or more welding material properties, a fill-volume management, or an indication of surface or subsurface defects.

23. The method of claim 19, further comprising:
performing one or more examination processes on the welded joint; and
determining the indication of the quality of the welded joint based on the one or more examination processes.

24. The method of claim 19, wherein determining the welding envelope comprises:
using the correlated data set as a training set in a machine learning model; and
training the machine learning model using the correlated data set to create a trained model, wherein the welding envelope is the trained model.

25. The method of claim 19, wherein determining the welded envelop comprises:
performing a statistic analysis on the correlated data set, and
developing the welding envelope based on the statistical analysis of the correlated data set.
